(19) United States
(12) Patent Application Publication
(10) Pub. No.: US 2014/0034192 A1
(43) Pub. Date: Feb. 6, 2014

(54) TRIMMING MACHINE FOR WOOD, PARTICULARLY DOUBLE-END TENONER

(71) Applicant: Albert Rabensteiner, Sarentino (IT)

(72) Inventor: Albert Rabensteiner, Sarentino (IT)

(21) Appl. No.: 14/111,261

(22) PCT Filed: Mar. 15, 2012
(86) PCT No.: PCT/EP12/54604

§ 371 Date: Oct. 17, 2013

(30) Foreign Application Priority Data
Apr. 11, 2011 (IT) BZ2011A000014

(51) Int. Cl. B27B 1/00; B27B 7/00; B27B 31/08

(52) U.S. Cl. CPC B27B 1/00; B27B 31/08; B27B 7/00
USPC 144/4.6; 83/105

(57) ABSTRACT

Trimming machine for wood, particularly a trimming saw for trunks, comprising a machine casing, two lateral cutting tools for cutting a trunk on two non adjacent sides, transport means for bringing the trunk for cutting, separation means for separating wood shavings or chips on both sides of the cut trunk and cutting means on at least one side of the cut trunk, adjacent to both sides. According to the invention, the separation means consist of surfaces which are inclined with respect to the work surface and lift the wood shavings or chips above the third side of the trunk.

The present invention refers to a trimming machine for wood, particularly a tenoner, according to the identifying section of claim 1.

Trimming machines of this type are firstly known from U.S. Pat. No. 4,270,423. In this, a tree half-trunk is advanced on a work surface of the machine by means of a conveyor and is in the form of chains. The trunk is passed between two circular saws parallel to each other in order to laterally cut the half-trunk, i.e. in order to remove two side shavings from it. Precisely onto the two lateral saws above the work surface a horizontal circular saw is arranged to cut the upper shavings of the half-trunk, that is at the level of the laterally trimmed trunk up to which the lateral shavings have been removed. In order not to obstruct work at the outlet of the cut board, the lateral shavings are deviated by guides in the form of wedges which are introduced between the lateral shavings and the vertical plane of the laterally-cut half-trunk downstream of the vertical circular saws. The laterals shavings are hence laterally deviated in order to bring them out of the work surface into a housing means outside the lateral walls of the machine racking. Hence the lateral shavings are disposed of. The upper shavings are brought up above the upper trimmed plane of the machined board.

It can be noted that this trimming machine of the known type is equipped with deviation devices for the lateral shavings to bring them laterally outside the machine racking to dispose of them laterally. In many circumstances, this solution is very unstable when there is not much space since the removal device of the shavings considerably increases the lateral dimensions of the machine.

The object of the present invention is therefore to perfect a machine of the above-described type and to provide a machine which is less bulky with respect to that previously described.

This object is achieved by a trimming machine for wood, particularly a tenoner, with the characteristics of the identifying section of claim 1.

Providing a work surface for a trimming machine downstream of the lateral cutting tools of an upward ramp guide, the lateral shavings or chips can be raised and brought onto a horizontal cutting tool in order to be disposed of in the transport direction together with the upper and/or lower shavings cut using the upper cutting tool.

This arrangement makes it possible to minimize the lateral dimensions of the trimming machine according to the invention with respect to one of the known type as described above.

Obviously, the lateral shaving or chips can be appropriately guided between the cut surface of the wood to be trimmed and itself, envisaging between the lateral cutting tools and the cutting tool a guide profile adapted to prevent any contact between the shavings and the cut wall of the board.

In a preferred embodiment, the vertical blades of the circular saw move in the same direction as the transport direction of the half-trunk.

Further details and features are shown in the claims and the following description of a preferred embodiment, depicted in the attached drawing, wherein

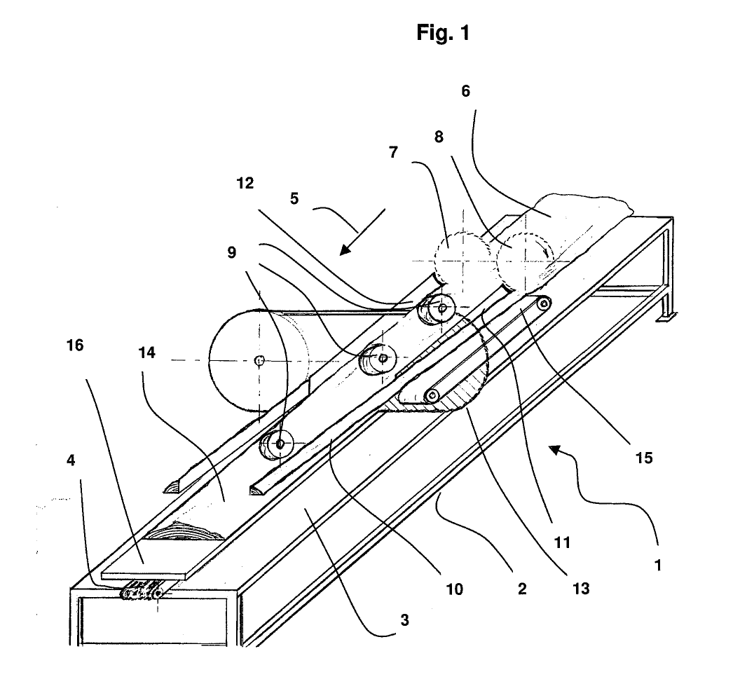

FIG. 1 is a schematic prospective view of a wood trimming machine according to the invention,

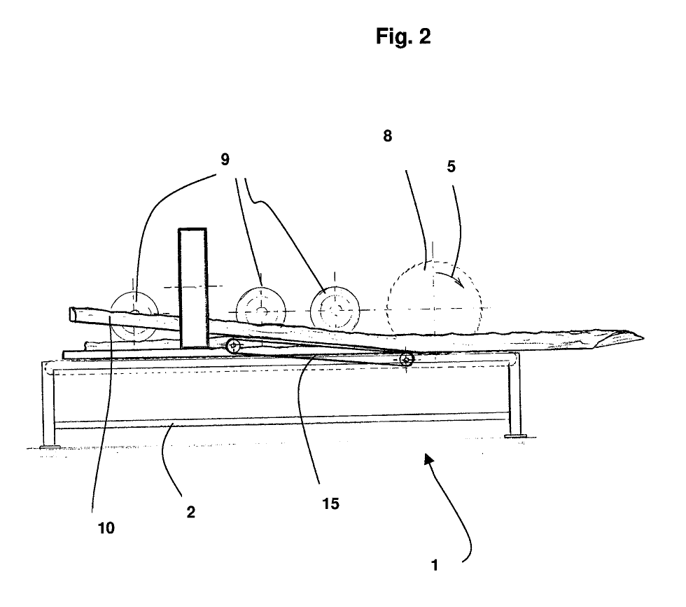

FIG. 2 is a lateral view of FIG. 1.

In the Figures, reference number 1 indicates a wood trimming machine as a whole, in this case a tenoner. The trimming machine 1 comprises a racking 2 which has a work surface 3 and a conveyor 4 on the plane itself. The conveyor 4 is adapted to be actuated in the working direction 5. On the conveyor 4 a half-trunk 6 can be rested which then undergoes the cutting process. For the vertical cutting operation, saws 7 and 8 are envisaged parallel to each other at an adjustable mutual distance. In order to keep the half-trunk on conveyor 4 pressure rollers 9 act on the upper side of the half-trunk. At the outlet of circular saws 7 and 8 the lateral shavings 10 from the trunk are cut. Between these and the machined part of the half-trunk 6, on two sides of the half-trunk lateral guides 11 and 12 are arranged in order to keep the lateral shavings 10 separate from the machined part. Subsequently, at a distance from circular saws 7 and 8 a belt saw 13 is arranged at an adjustable height above the work surface 3 for horizontal operations with respect to the plane. The belt saw 13 processes the half-trunk 6 in order to remove the upper shavings 14.

In order to prevent the lateral shavings 10 from obstructing the belt saw 13 and in order to save the maximum lateral dimensions of the trimming machine 1, on the work surface between the vertical circular saws 8 and 9 and the horizontal belt saw 13, inclined guides 15 are arranged at each side of the trunk which rise in the direction of the belt saw 13 in order to bring the lateral shavings above the part of the belt saw which is engaged with the half-trunk. Hence, from the trimming machine 1 a board 16 exits completely free from shavings.

Various embodiments and modifications are possible without leaving the scope protected by the claim.

Hence, the transport means can be chains or belts. The saws can be either circular saws or belt saws. All the described guides can be adjusted just as the slope of the inclined guide can be adjusted.

### KEY OF REFERENCE NUMBERS

1 trimming machine
2 racking
3 work surface
4 conveyor
5 work direction
6 half-trunk
7 saw
8 saw
9 pressure rollers
10 lateral shavings
11 lateral guide
12 lateral guide
13 belt saw
15 inclined guides
16 board

1. A trimming machine for wood, particularly a trimming saw for trunks, comprising a machine casing, two lateral cutting tools for cutting a trunk on two non adjacent sides, transport means for bringing the trunk for cutting, separation means for separating wood shavings or chips on both sides of the cut trunk and cutting means on at least one side of the cut trunk, adjacent to both sides, wherein the separation means consist of surfaces which are inclined with respect to the work surface and lift the wood shavings or chips above the third side of the trunk.

2. The trimming machine according to claim 1, wherein two vertical cutting tools are envisaged parallel to each other and adapted to cut longitudinally a half-trunk, transport means for bringing the half-trunk for cutting, separation means adapted to remove the lateral wood shavings from the cut half-trunk and cutting means orthogonal to the cuts parallel to each other, the separation means being formed by inclined surfaces with respect to the work surface adapted to lift the wood shavings above the horizontal cutting tools.

3. The trimming machine according to claim 1, wherein the transport means is formed by chains.

4. The trimming machine according to claim 1, wherein the lateral wood shavings are guided between the cut wall and itself a guiding profile being envisaged between the vertical cutting tools and the horizontal cutting tools adapted to prevent any contact between the wood shavings and the wall cut by the axis.

5. The trimming machine according to claim 1, wherein it comprises a casing having a work surface and a conveyor on the surface itself, the conveyor being adapted to be actuated in the working direction, on the conveyor a half-trunk to be cut can be positioned, for the vertical cutting operation circular saws being envisaged parallel to each other at an adjustable mutual distance, in order to keep the half-trunk on the conveyor on the upper side of the half-trunk some pushing rollers acting, at the outlet of the circular saws from the half-trunk lateral wood shavings being cut, between these and a processed wall of the half-trunk, on the two sides of the half-trunk lateral guides being arranged to keep the lateral wood shavings separate from the processed part, at a distance from the circular saws a bandsaw being arranged at an adjustable height above the work surface for horizontal processing with respect to the surface, the bandsaw processing the half-trunk to remove the upper wood shavings, on the work surface between the vertical circular saws and the horizontal bandsaw, inclined ramp guides are arranged at each side of the trunk, such guides rising towards the bandsaw in order to bring the lateral wood shavings above the part of the bandsaw engaging the half-trunk.

6. The trimming machine according to claim 1, wherein the blades of the vertical circular saw move towards the transport direction of the half-trunk.

7. The trimming machine according to claim 1, wherein the ramp guides are conveyor belts.

8. The trimming machine combined with a wood splitter or a woodworking machine according to claim 1, wherein with a single operation the half-trunk enters the trimming fully machine and exits free from lateral and upper wood shavings or chips in order to form a finished board or plank.
